(19) United States
(12) Patent Application Publication
(10) Pub. No.: US 2010/0126174 A1
(43) Pub. Date: May 27, 2010

(54) GAS TURBINE COMBUSTION CHAMBER

(76) Inventors: Rainer Brinkmann, Duisburg (DE); Holger Huitenga, Mulheim (DE); Eric Norster, Newark (GB)

Correspondence Address: GREER, BURNS & CRAIN, 300 S WACKER DR, 25TH FLOOR, CHICAGO, IL, 60606, US

(21) Appl. No.: 12/440,314

(22) PCT Filed: Sep. 4, 2007
(86) PCT No.: PCT/EP2007/007696

§ 371 Date: Dec. 9, 2009

(30) Foreign Application Priority Data
Sep. 7, 2006 (DE) 10 2006 042 124.8

(51) Int. Cl. F02C 7/22; F02C 3/14

(52) U.S. Cl. 60/737; 60/755

(57) ABSTRACT

A combustion chamber including: a flame tube having, in the direction of flow, a mixing zone for mixing a fuel with air to form a fuel-air mixture, as well as a primary combustion zone and a post-primary combustion zone, at least one opening being provided in the area of the mixing zone and in the area of the post-primary combustion zone in order to conduct compressed air into the flame tube, wherein supplied compressed air is used to cool the flame tube and, via the openings in the area of the mixing zone and in the area of the post-primary combustion zone, passes partly into the mixing zone and into the post-primary combustion zone.

The present invention relates to a combustion chamber that is provided in particular for use in a gas turbine. More precisely, the present invention relates to the conduction of the compressed air that is supplied to the combustion chamber.

The typical design of a gas turbine, consisting of a compressor area, a combustion chamber area, and a turbine area, has long been known and is not described in more detail in the following. The compressed air that is supplied to the combustion chamber is introduced into a flame tube during the combustion process, and is also used to cool the combustion chamber. As a result of legislative guidelines, a goal of research and development work in the area of gas turbines has been to continually reduce the pollutant emissions of gas turbines. The emphasis here is on the pollutants NO_{N}, CO₂, and CO, as well as uncombusted hydrocarbons. The pollutants during the combustion process of a gas turbine can be achieved for example through a lean mixing of the fuel-air mixture, i.e. more compressed air must be added to the fuel-air mixture, or through an optimal temperature distribution in the flame tube.

In order to reduce costs, it is desirable to increase the efficiency of gas turbines, for example through higher temperatures. Materials technology sets the limits of turbomachine engineering here, so that a cooling of the components of the combustion chamber in order to achieve higher temperatures during the combustion process is a measure widely used in the prior art.

EP 0 732 546 B1 discloses a design from the prior art whose aim is to meet these requirements. The compressed air that is supplied to the combustion chamber from the compressor area of the gas turbine is divided into two substreams. One substream is used for the combustion in the flame tube, and another is used to cool the external walls of the combustion chamber, the cooling air subsequently entering into the post-primary combustion zone.

A disadvantage of this design is that only a previously defined portion of the compressed airflow is provided for the cooling. That is, the more low-pollutant the design of a gas turbine is, the less cooling air is available. Consequently, the efficiency of the gas turbine must remain low in order to facilitate the lower pollutant emission.

Another prior art document, EP 0 896 193 B1, attempts to remedy the stated disadvantages by supplying the compressed air used for cooling via a mixing zone after the combustion. For this purpose, the cooling air must flow along the entire wall of the flame tube from the downstream side of the combustion chamber. The cooling efficiency of this type of cooling is therefore comparatively low.

The prior art according to EP 0 896 193 B1 thus has the disadvantage that it is not possible to provide direct cooling in the interior of the flame tube through openings in the wall in the area of the post-primary combustion zone, or secondary zone. This prior art thus does not achieve an optimal cooling efficiency, and is limited in the manner of operation of its gas turbine.

Taking into account the described prior art, it is therefore the object of the present invention to provide a combustion chamber of a gas turbine, and a gas turbine, that meet high environmental standards while also achieving improved efficiency.

This object is achieved through the independent claims of the present invention. The dependent claims represent advantageous embodiments of the present invention.

The present invention provides a combustion chamber for a gas turbine. The flame tube of the combustion chamber is divided, in the direction of flow, at least into a mixing zone for mixing a fuel with air to form a fuel-air mixture, a primary combustion zone, or primary zone, and a post-primary combustion zone, or secondary zone. In the area of the mixing zone, fashioned in the vicinity of the burner, as a rule at least one opening into the interior of the flame tube via ducts of the burner is provided. In the area of the post-primary combustion zone, at least one opening, called the mixing opening, is likewise provided. This at least one opening, or mixing opening, is used to cool the combustion process. Compressed air, which was previously compressed in the compressor area of the gas turbine, passes into the flame tube via the named openings. The compressed air is provided in order to cool the flame tube, and parts of it pass via the described openings into the mixing zone and into the post-primary combustion zone.

Due to the cooling of the flame tube with the air that is subsequently supplied for the combustion, the air for the combustion passes into the burner of the combustion chamber with a higher temperature. Because the combustion temperature is raised in this way, the gas turbine can be operated with less fuel while nonetheless reaching the same temperature. This measure thus increases the efficiency of the gas turbine. In addition, the new arrangement makes it possible for the combustion gases also to be cooled in the post-primary combustion zone. In addition, the supply of air to the combustion process can be made variable, because theoretically all of the compressed air could be supplied to the combustion process.

In the following, the present invention is explained in more detail on the basis of a specific embodiment, illustrated by a drawing.

The FIGURE shows a schematic cross-sectional view of a combustion chamber according to the present invention.

Reference character 1 indicates a combustion chamber according to the specific embodiment, having a flame tube 3 and a baffle screen 2 situated radially outside the flame tube. Combustion chamber 1 is a component of a gas turbine (not shown) that is operated using gaseous and/or liquid fuel. The flame tube is mostly cylindrical in its construction. Via a compressor air duct, compressed air flows onto the baffle screen. Through openings 4 of the baffle screen, the compressed air, which flows from a compressor, i.e. from the compressor area of the gas turbine, to the combustion chamber, is divided into numerous individual streams.

Preferably, openings 4 of the baffle screen are fashioned as nozzles, so that the inflowing compressed air impinges in jet form. The arrangement and geometry of openings 4 of the baffle screen can be adjusted in such a way that the desired degree of cooling is achieved on the surface of the flame tube. In addition, the division of the impingement cooling into air portion 11 and air portion 12 is realized so as to be regulable. In this specific embodiment, this is achieved in that the geometry of openings 5 to the post-primary combustion zone 18 can be modified during operation. Through the cooling of flame tube 3, the life span of the machine elements used is increased, and the air of the burner flow portion 11, 13 and of the mixing opening flow portion 12 is heated.

In this specific embodiment, the baffle screen is fashioned as a perforated plate that surrounds the flame tube (3) circumferentially. Because the compressed air is not only conducted along the outer wall of flame tube 3, but also impinges on the outer surface of the flame tube with increased speed and in numerous individual streams, preferably as a result of the nozzle effect of the openings of perforated plate 2, the cooling effect is noticeably increased. Although the FIGURE shows baffle cooling air flowing onto flame tube 3 in perpendicular fashion, the flow of compressed air directed onto flame tube 3 can also impinge on flame tube 3 at an angle, i.e. not in perpendicular fashion. For this purpose, a device can preferably be provided in compressor air duct 9 in order to divide the flow of compressed air that is directed onto flame tube 3.

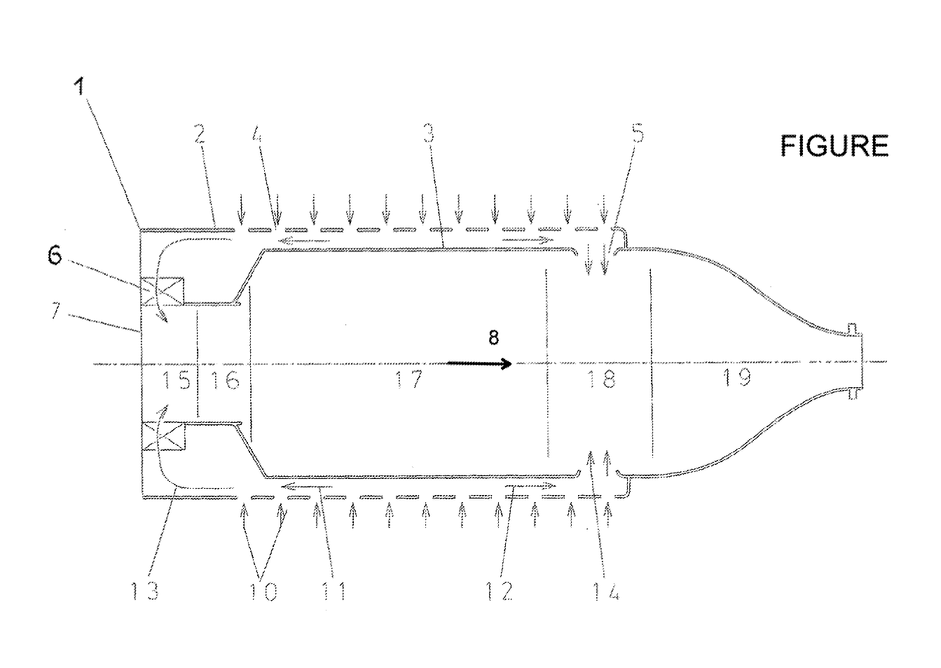

In addition, this specific embodiment of the present invention is also to be understood as open with regard to the zones in which the flame tube is cooled by impinging air. FIG. 1 shows a specific embodiment in which both the pre-primary and the post-primary combustion zones are cooled by impinging air. It is also for example possible to cool only the area of the primary combustion zone.

Nonetheless, the present invention is not limited to impingement cooling with individual streams 10 impinging on flame tube 3 in mostly perpendicular or angled fashion. Rather, it is also possible for a laminar flow along the outer wall of flame tube 3 to create the desired cooling effect. What is essential to the present invention is above all that the air used for cooling passes into flame tube 3 both via mixing openings 5 and also via openings 6. In addition, a combination of the depicted types of flows for the cooling of flame tube 3, as well as supplementation by other cooling methods known to those skilled in the art, is also conceivable.

The air, preheated in this way, passes into burner 7 via air duct 6. There the air is pre-mixed with the fuel, which flows essentially along the fuel stream. Because, due to the pre-heated air used for the cooling of the flame tube, the temperature of the fuel-air mixture is increased in comparison with conventional fuel-air mixtures, the gas turbine can reach the same temperature as gas turbines known from the prior art, with a reduced use of fuel.

According to the specific embodiment, the supplied compressed air is used essentially entirely for the cooling of flame tube 3, and is divided into a flow portion 11, 13 to opening 6 of mixing zone 15 and a flow portion 12 to opening S of post-primary combustion zone 18. Mixing opening flow 14 then flows via a plurality of mixing openings 5 into flame tube 5, essentially perpendicular to fuel stream 8. This achieves improved cooling performance. The flow-through can be realized so as to be controllable or regulable through mixing openings 5 and/or through opening 6 to mixing zone 15. This can take place for example by modifying the flow-through cross-section through the named openings, but also by using all other measures known to those skilled in the art.

1. A combustion chamber comprising: a flame tube having, in the direction of flow, a mixing zone for mixing a fuel with air to form a fuel-air mixture, as well as a primary combustion zone and a post-primary combustion zone, at least one opening being provided in the area of the mixing zone and in the area of the post-primary combustion zone in order to conduct compressed air into the flame tube, wherein supplied compressed air is used to cool the flame tube and, via the openings in the area of the mixing zone and in the area of the post-primary combustion zone, passes partly into the mixing zone and into the post-primary combustion zone.

2. The combustion chamber as recited in claim 1, characterized in that the cooling of the flame tube takes place through impingement cooling on the outer surface of the flame tube.

3. The combustion chamber as recited in claim 1, characterized in that a baffle screen is provided radially externally to the flame tube in order to divide the compressed air into individual streams.

4. The combustion chamber as recited in claim 3, characterized in that the baffle screen is fashioned as a perforated plate that surrounds the flame tube in the circumferential direction.

5. The combustion chamber as recited in claim 4, characterized in that the holes in the perforated plate are fashioned as nozzles.

6. The combustion chamber as recited in claim 1, characterized in that a part of the supplied compressed air passes directly via the opening of the post-primary combustion zone into the flame tube.

7. The combustion chamber as recited in claim 1, characterized in that the compressed air supplied to the combustion chamber is provided entirely for the cooling of the flame tube, and is divided into a flow portion to the opening of the mixing zone and a flow portion to the opening of the post-primary combustion zone.

8. The combustion chamber as recited in claim 3, characterized in that the baffle screen covers only the primary combustion zone or covers the primary combustion zone and the post-primary combustion zone.

9. The combustion chamber as recited in claim 1, characterized in that the flow-through through the opening to the post-primary combustion zone and/or the flow-through through the opening to the mixing zone is capable of being controlled or regulated, in particular during operation.

10. The combustion chamber as recited in claim 9, characterized in that the controlling or regulation of the flow-through is accomplished by modification of a flow-through cross-section of the opening to the post-primary combustion zone and/or of the opening to the mixing zone, in particular during operation.

11. The combustion chamber as recited in claim 1, characterized in that the combustion chamber is operated using gaseous and/or liquid fuel.

12. A gas turbine having a combustion chamber as recited in claim 1, characterized in that the compressed air is provided via the compressor area of the gas turbine and suitable connecting elements between the compressor area and the combustion chamber.
